(19) United States
(12) Patent Application Publication
(10) Pub. No.: US 2008/0066116 A1
(43) Pub. Date: Mar. 13, 2008

(54) Active digital TV antenna

(75) Inventors: Chi-Ming Chiang, Pa-Te City (TW); Annie Yang, Pa-Te City (TW); Chih-Cheng Chien, Pa-Te City (TW)

Correspondence Address: BRUCE H. TROXELL, SUITE 1404, 5205 LEESBURG PIKE, FALLS CHURCH, VA, 22041, US

(73) Assignee: Auden Techno Corp.

(21) Appl. No.: 11/518,387

(22) Filed: Sep. 11, 2006

(51) Int. Cl. H04N 7/20

(52) U.S. Cl. 725/72

(57) ABSTRACT

An active digital TV antenna, the antenna mainly has a planar antenna and a variable capacitor connected to the planar antenna; the variable capacitor is used to adjust a capacitance value and an inductance value of the planar antenna to change the range of frequency band of a signal received by the planar antenna. Therefore, the entire volume of the antenna can be reduced to be suitable for applying in an active electronic machine such as a notebook or a mobile phone.

### BACKGROUND OF THE INVENTION

1. Field of the Invention

The present invention is related to an active digital TV antenna, and especially to an active digital TV antenna with a miniaturized volume.

2. Description of the Prior Art

For digital TVs nowadays, the DVB-T (Digital Video Broadcasting-Terrestrial) transmitting system is the main stream, because it can receive a signal during action and this is the most important reason beside that it can show pictures with high analyzed quality indoors. The frequency band of the DVB-T transmitting system is set within 470˜862 MHz.

Allocating a digital TV on an active electronic machine, such as on a notebook or a mobile phone etc., there has been presently a problem, i.e., in considering for frequency bands, an active electronic machine must be provided thereon with an antenna with a larger volume. Provision of such an antenna is against the idea of miniaturization of active electronic machines; thus improvement is required.

### SUMMARY OF THE INVENTION

In order to solve the problem of having a larger volume of a conventional active digital TV antenna, the present invention provides a miniaturized antenna that is suitable for installing on an active electronic machine.

The main technique of the present invention is to connect a variable capacitor to a planar antenna, the variable capacitor is used to adjust a capacitance value and an inductance value in matching with the antenna, this can change the range of frequency of a received signal, in order that the planar antenna with a small volume can receive a digital TV signal in the range of frequency band of 470˜862 MHz. Hence the entire volume of the antenna can be reduced to be suitable for applying in an active electronic machine such as a notebook or a mobile phone.

The present invention further is provided with an adjusting means to automatically detect a frequency received for adjusting a capacitance value.

The present invention will be apparent in its structure and function after reading the detailed description of the preferred embodiment thereof in reference to the accompanying drawings.

### BRIEF DESCRIPTION OF THE DRAWINGS

FIG. 1 is a perspective view showing the appearance of the present invention;

FIG. 2 is circuit diagram of the present invention;

FIGS. 3A to 3C are frequency-standing wave voltage ratio diagrams of a variable capacitor of the present invention when its capacitance is the largest, in the middle and the smallest respectively;

FIG. 4 is a chart showing the gains at various frequencies in free spaces in an H-plane and an E-plane of the present invention used on a mobile phone;

FIG. 5 shows a chart showing a simulated H-plane radiation field type of the present invention with a frequency of 470 MHz;

FIG. 6 shows a chart showing a simulated H-plane radiation field type of the present invention with a frequency of 560 MHz;

FIG. 7 shows a chart showing a simulated H-plane radiation field type of the present invention with a frequency of 660 MHz;

FIG. 8 shows a chart showing a simulated H-plane radiation field type of the present invention with a frequency of 760 MHz;

FIG. 9 shows a chart showing a simulated H-plane radiation field type of the present invention with a frequency of 860 MHz;

FIG. 10 shows a chart showing a simulated E-plane radiation field type of the present invention with a frequency of 470 MHz;

FIG. 11 shows a chart showing a simulated E-plane radiation field type of the present invention with a frequency of 560 MHz;

FIG. 12 shows a chart showing a simulated E-plane radiation field type of the present invention with a frequency of 660 MHz;

FIG. 13 shows a chart showing a simulated E-plane radiation field type of the present invention with a frequency of 760 MHz;

FIG. 14 shows a chart showing a simulated E-plane radiation field type of the present invention with a frequency of 860 MHz.

### DETAILED DESCRIPTION OF THE PREFERRED EMBODIMENT

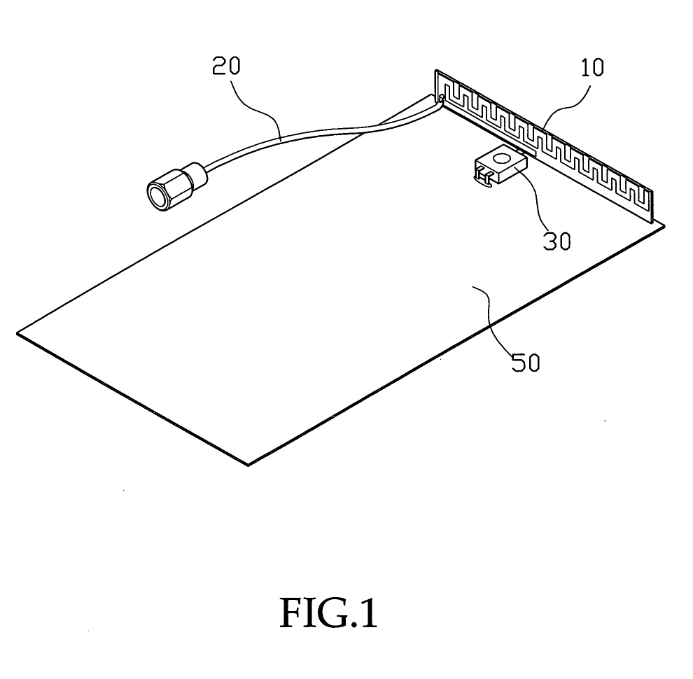

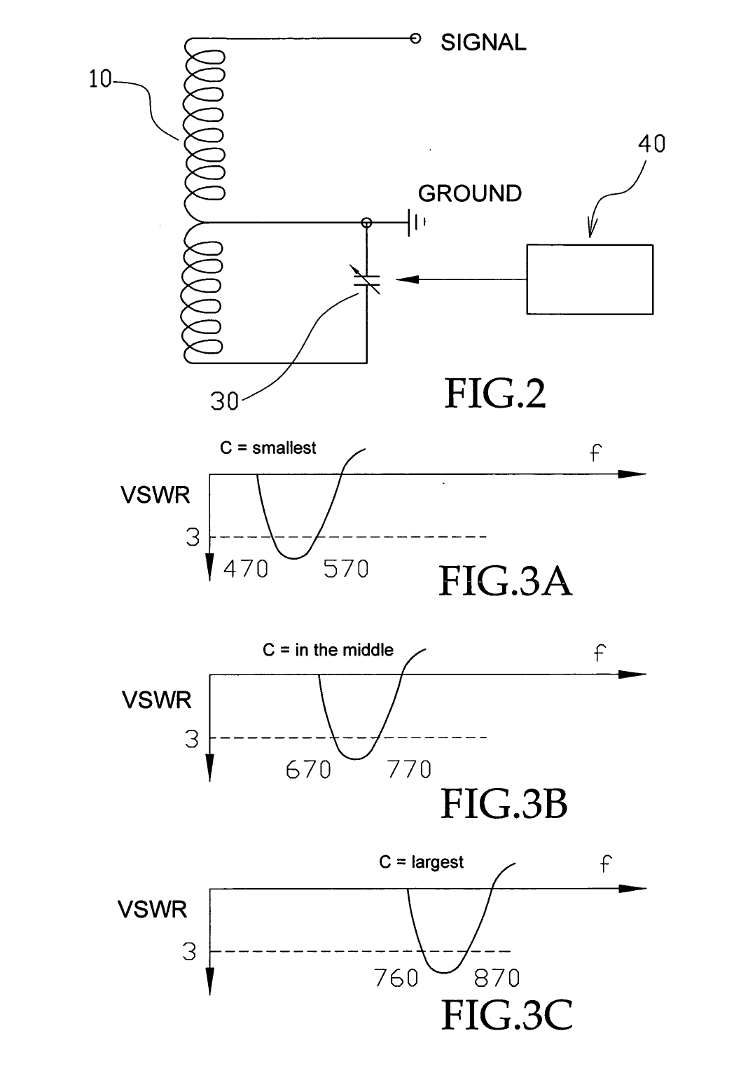

Referring to FIGS. 1 and 2, an active digital TV antenna of the present invention is a planar antenna 10 provided on a circuit board 50, the planar antenna 10 is connected via a core wire of a coaxial transmitting line 20 to a (signal) feed-in end, and is connected via an outer layer to the ground.

The planar antenna 10 is connected with a capacitor 30 to adjust the capacitance value and an inductance value to change the point of resonant frequency of the planar antenna 10.

And further referring to FIG. 2, the capacitor 30 is controlled with an adjusting device 40; the adjusting device 40 can be manually controlled, or can automatically detect a received frequency through a built-in program on a chip to adjust the capacitance of the capacitor 30 to a suitable value.

Referring to FIGS. 3A to 3C which show frequency-standing wave voltage ratio (VSWR) diagrams of the variable capacitor 30 of the present invention when its capacitance is the largest, in the middle and the smallest respectively; for example, in FIG. 3A, its capacitance C is the smallest, the range of frequency of its point of resonant frequency (VSWR=3) is in the range of 470˜570 MHz. When the capacitance C is adjusted to be in the middle, as shown in FIG. 3B, the range of frequency of its point of resonant frequency is in the range of 670˜790 MHz. And when the capacitance C is adjusted to be the largest, as shown in FIG. 3C, the range of frequency of its point of resonant frequency is in the range of 760˜870 MHz.

By adjusting the capacitance value and the inductance value of the capacitor 30, the planar antenna 10 can receive a digital TV signal in the range of frequency band of 470˜862 MHz; hence all frequency bands of digital TV signals can be received by a planar antenna with a miniaturized volume. And hence the present invention is suitable for applying in an active electronic machine such as a notebook or a mobile phone.

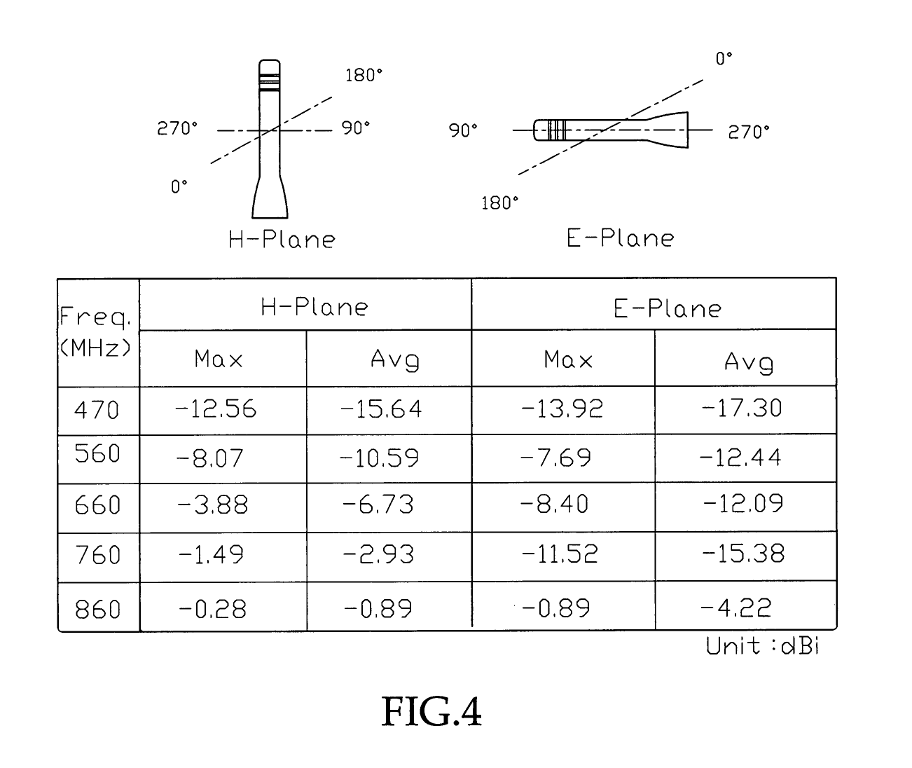

Referring to FIG. 4, it shows a chart showing the gains at various frequencies in free spaces in an H-plane and an E-plane respectively of the present invention used on a mobile phone.

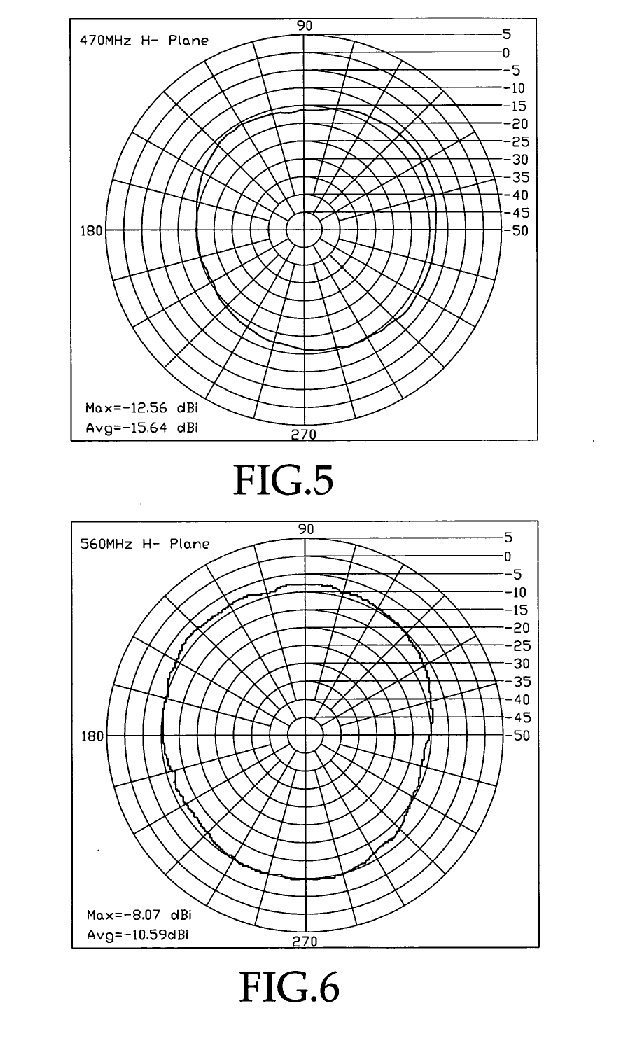

FIG. 5 shows a chart showing a simulated H-plane radiation field type of the present invention with a frequency of 470 MHz; the largest gain of the H-plane is −12.56 dBi, its average gain is −15.64 dBi.

FIG. 6 shows a chart showing a simulated H-plane radiation field type of the present invention with a frequency of 560 MHz; the largest gain of the H-plane is −8.07 dBi, its average gain is −10.59 dBi.

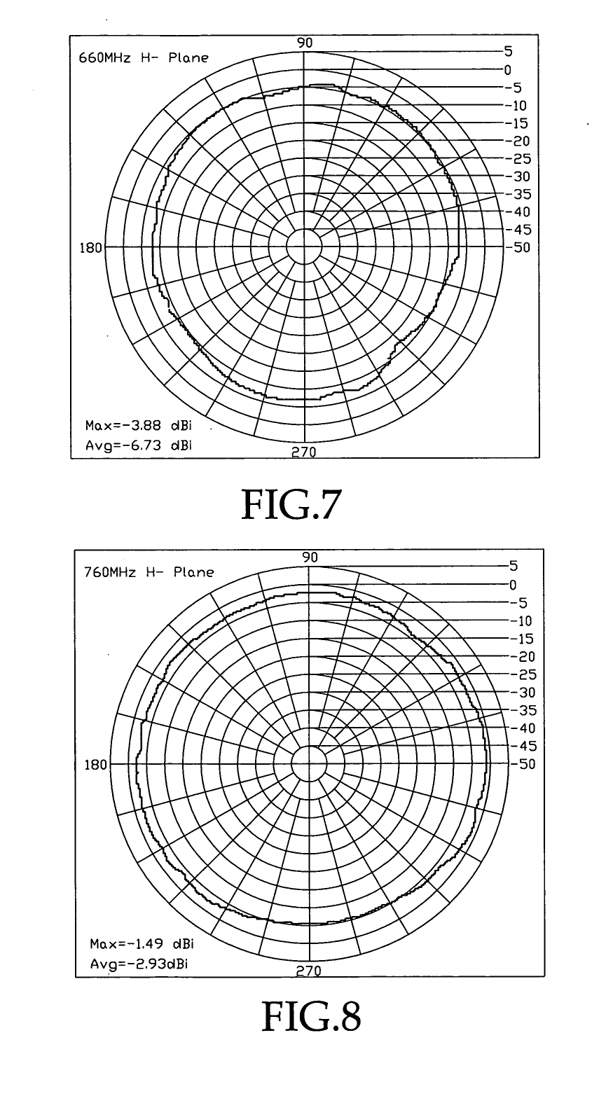

FIG. 7 shows a chart showing a simulated H-plane radiation field type of the present invention with a frequency of 660 MHz; the largest gain of the H-plane is −3.88 dBi, its average gain is −6.73 dBi.

FIG. 8 shows a chart showing a simulated H-plane radiation field type of the present invention with a frequency of 760 MHz; the largest gain of the H-plane is −1.49 dBi, its average gain is −2.93 dBi.

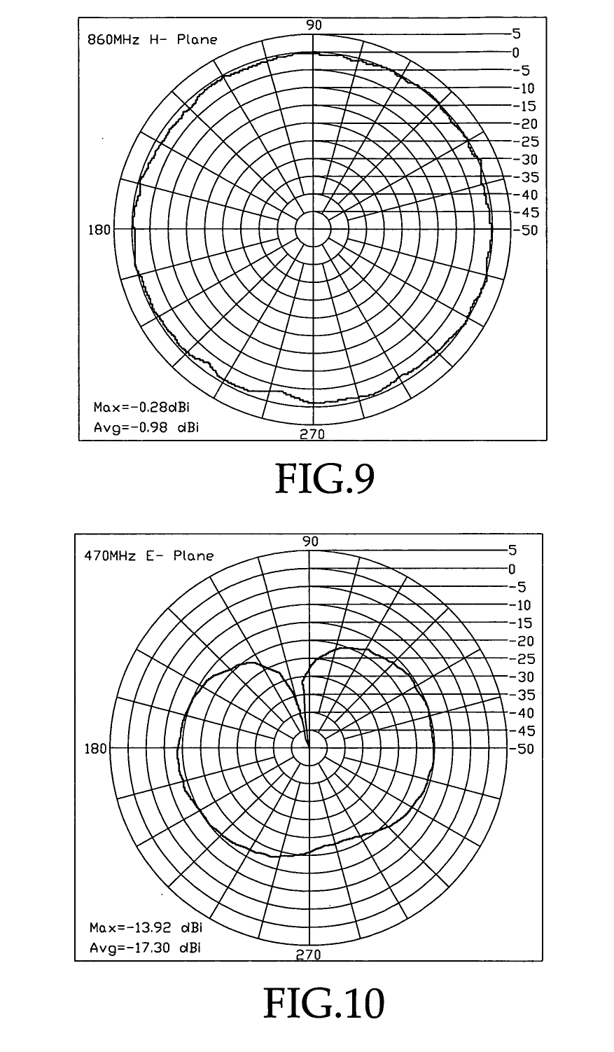

FIG. 9 shows a chart showing a simulated H-plane radiation field type of the present invention with a frequency of 860 MHz; the largest gain of the H-plane is −0.28 dBi, its average gain is −0.98 dBi.

FIG. 10 shows a chart showing a simulated E-plane radiation field type of the present invention with a frequency of 470 MHz; the largest gain of the E-plane is −13.92 dBi, its average gain is −17.30 dBi.

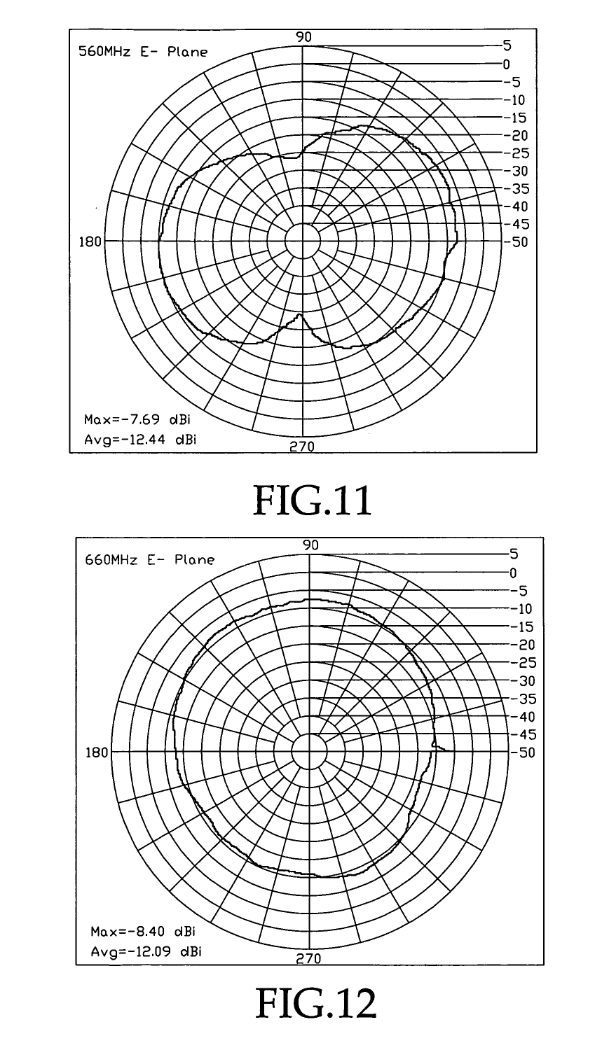

FIG. 11 shows a chart showing a simulated E-plane radiation field type of the present invention with a frequency of 560 MHz; the largest gain of the E-plane is −7.69 dBi, its average gain is −12.44 dBi.

FIG. 12 shows a chart showing a simulated E-plane radiation field type of the present invention with a frequency of 660 MHz; the largest gain of the E-plane is −8.40 dBi, its average gain is −12.09 dBi.

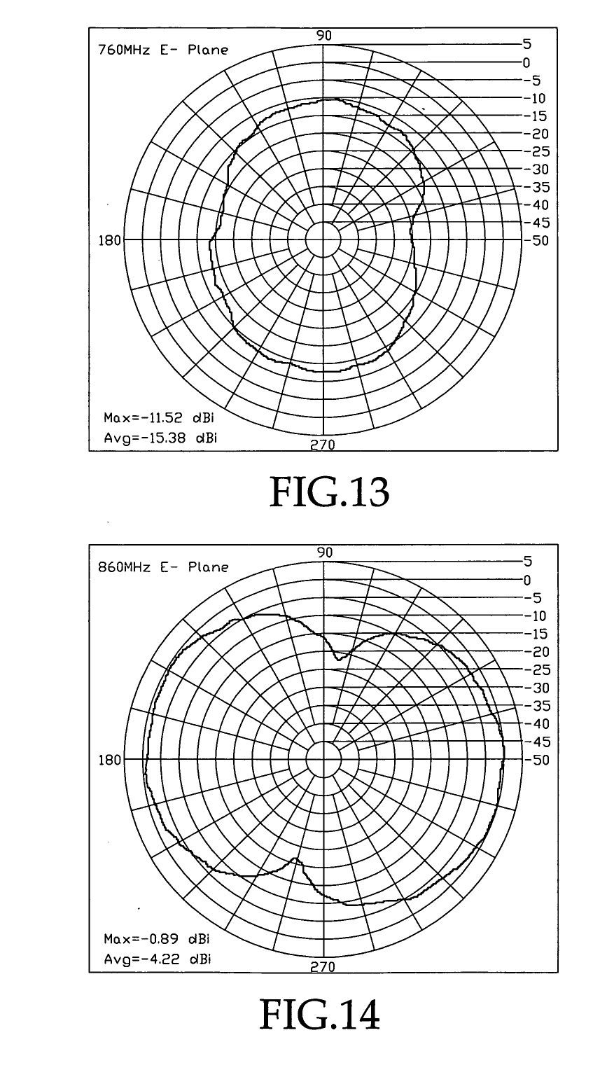

FIG. 13 shows a chart showing a simulated E-plane radiation field type of the present invention with a frequency of 760 MHz; the largest gain of the E-plane is −11.52 dBi, its average gain is −15.38 dBi.

FIG. 14 shows a chart showing a simulated E-plane radiation field type of the present invention with a frequency of 860 MHz; the largest gain of the E-plane is −0.89 dBi, its average gain is −4.22 dBi.

We can see from this test report that the performances of the present invention are all quite excellent; thereby the present invention is an ideal active digital TV antenna.

The preferred embodiment cited above is only for illustrating the present invention. It will be apparent to those skilled in this art that various modifications or changes can be made to the elements of the present invention without departing from the spirit and scope of this invention; and all such modifications and changes also fall within the scope of the appended claims and are intended to form part of this invention.

1. An active digital TV antenna, said antenna comprises: a planar antenna and a variable capacitor connected to said planar antenna; said variable capacitor is used to adjust a capacitance value and an inductance value of said planar antenna to change a point of resonant frequency of said planar antenna, in order that said planar antenna receives a signal in the range of frequency band of a digital TV.

2. The active digital TV antenna as in claim 1, wherein said antenna is provided on an active electronic machine.

3. The active digital TV antenna as in claim 1, wherein said variable capacitor is controlled with an adjusting device.

4. The active digital TV antenna as in claim 3, wherein said adjusting device is manually controlled.

5. The active digital TV antenna as in claim 3, wherein said adjusting device automatically detects a received frequency through a built-in program on a chip to adjust said capacitance value of said capacitor to a predetermined value.

6. The active digital TV antenna as in claim 1, wherein said digital TV signal is in the range of frequency band of 470˜862 MHz.
